(19) United States
(12) Patent Application Publication
(10) Pub. No.: US 2012/0121832 A1
(43) Pub. Date: May 17, 2012

(54) DECORATION PANEL AND HOME APPLIANCE EQUIPPED THEREWITH

(76) Inventors: Hyungi Jung, Seoul (KR); Minju Son, Seoul (KR)

(21) Appl. No.: 13/386,161

(22) PCT Filed: Aug. 19, 2010
(86) PCT No.: PCT/KR10/05507

§ 371 Date: Jan. 20, 2012

(30) Foreign Application Priority Data
Aug. 19, 2009 (KR) 10-2009-0076647

(51) Int. Cl. B32B 3/10; B32B 1/06; B32B 1/02; B32B 17/10; B32B 7/12

(52) U.S. Cl. 428/34.6; 428/201

(57) ABSTRACT

The present invention relates to a decoration panel for a home appliance and a home appliance equipped with the decoration panel. According to the present invention, it is possible to reduce the manufacturing cost by using green glass instead of white glass and achieve a clear white color at substantially the same level as using the white glass.

### TECHNICAL FIELD

The present invention relates to a decoration panel and a home appliance equipped with the decoration panel.

### BACKGROUND ART

In general, home appliances, such that a refrigerator, a washing machine, a cooker, an air conditioner, and a dish washer, are equipped with a main body or a door, which is made of a steel plate or plastic. Further, the main body or the door is manufactured to show various impression of a color, feel of a material, or patterns.

The home appliances have been more enhanced in quality and discriminated in design in accordance with improvement of the standard of living and the consumer's preference. In particular, not only the function, but the design is one of the important factor for deciding purchase in recent years, such that home appliances given with various patterns and feel of a material has been developed.

Typically, the decoration member for the main body or the door of the home appliances is made of VCM (Vinyl Coated Metal) plate printed with various colors and patterns. Further, in order to show various impression of a color and feel of a material and express luxurious feel, the decoration member is made of tempered glass and used for making the entire or a portion of the external appearance of the home appliances.

In particular, recently, tempered glass printed with various colors and patterns has been used for the decoration member forming at least a portion of the main body or the door of the home appliances. The decoration members made of tempered glass are usually directly printed with colors and patterns by silk-screen painting. However, the silk screen has a problem in that the working process is not continuous, the working speed is low, and the defective proportion is high due to the featured in the manufacturing process, such that it is not efficient and the manufacturing cost increases.

### DISCLOSURE OF INVENTION

### Technical Problem

An embodiment of the present invention provides a decoration panel for a home appliance having an effect substantially equivalent to using white glass, by using green glass instead of white glass, for tempered glass, and effectively attenuating the blue color of the green glass itself.

### Solution to Problem

An aspect of the present invention provides a decoration panel for a home appliance, which includes: a green glass defining the external appearance of the appliance; a first film disposed on a rear side of the green glass; and a base supporting layer supporting the first film from a rear side of the first film, wherein the first film includes: a first base layer formed on the rear side of the green glass; a printed layer formed on a rear side of the first base layer by gravure printing; and a first reflective layer printed with a print ink containing a white inorganic pigment on a rear side of the printed layer by gravure printing to shield the green color of the green glass.

Further, another aspect of the present invention provides a home appliance, which includes: a main body or a door defining the external appearance; and a decoration panel provided on the main body or the door, wherein the decoration panel includes: a green glass defining the external appearance of the home appliance; a first film disposed on a rear side of the green glass; and a base supporting layer supporting the first film from a rear side of the first film, and the first film includes: a first base layer formed on the rear side of the green glass; a printed layer formed on a rear side of the first base layer by gravure printing; and a first reflective layer printed with a print ink containing a white inorganic pigment on a rear side of the printed layer by gravure printing to shield the green color of the green glass.inted layer by gravure printing to cover the green color of the green glass.

### Advantageous Effects of Invention

According to the decoration panel and a home appliance equipped with the decoration panel according to an embodiment of the present invention, it is possible to achieve a decoration panel by attaching a first film and a second film, which are continuously printed by gravure printing, to the rear side of green glass. Therefore, it is possible to easily manufacture, as compared with when every sheets are printed on green glass by silk-screen printing in the related art, and improve productivity, because it is possible to quickly manufacture the decoration panel.

Further, the green color of green glass can be shown to the outside, when the external appearance of the decoration panel is defined by green glass and a printed layer is printed with a white background. However, according to the present invention, it is possible to shield the green color of the green glass, because reflectivity is improved by color reflection due to a first reflective layer printed with a white inorganic pigment on the rear side of the printed layer and a second reflective layer printed with the same white inorganic pigment on the rear side of the first reflective layer.

Further, since a red solid-printing layer having a red color that is the complementary color of the green color of the green glass is formed on the rear side of the second reflective layer, reflected light attenuates the green color of the green glass by complementary colors contrast effect, such that the white color of the printed layer can be shown more clear.

In particular, when the decoration panel is formed by attaching a white printed film to the green glass, it is possible to express a perfect white color, even if inexpensive green glass is used instead of expensive white glass, such that it is possible to expect reduction of manufacturing cost.

### BRIEF DESCRIPTION OF DRAWINGS

FIG. 1 is a cross-sectional view of a decoration panel according to an embodiment of the present invention;

FIG. 2 is a cross-sectional view schematically showing when light is reflected from the decoration panel according to an embodiment of the present invention;

FIG. 3 is a front view of a side-by-side refrigerator equipped with the decoration panel according to an embodiment of the present invention;

FIG. 4 is an exploded perspective view of the door shown in FIG. 3;

FIG. 5 is a perspective view of a lid type refrigerator equipped with the decoration panel according to an embodiment of the present invention;

FIG. 6 is a perspective view of an air conditioner equipped with the decoration panel according to an embodiment of the present invention;

FIG. 7 is a cross-sectional view taken along the line A-A′ of FIG. 6;

FIG. 8 is a perspective view of a washing machine equipped with the decoration panel according to an embodiment of the present invention;

FIG. 9 is a perspective view of a dish washer equipped with the decoration panel according to an embodiment of the present invention; and

FIG. 10 is a perspective view of a cooker equipped with the decoration panel according to an embodiment of the present invention.

### BEST MODE FOR CARRYING OUT THE INVENTION

Hereinafter, specific embodiments of the present invention are described in detail with reference to the accompanying drawings. However, the scope of the present invention is not limited to the embodiments but other retrogressive inventions or other embodiments included in the scope of the present invention can be easily proposed by adding, modifying, removing, etc. other components.

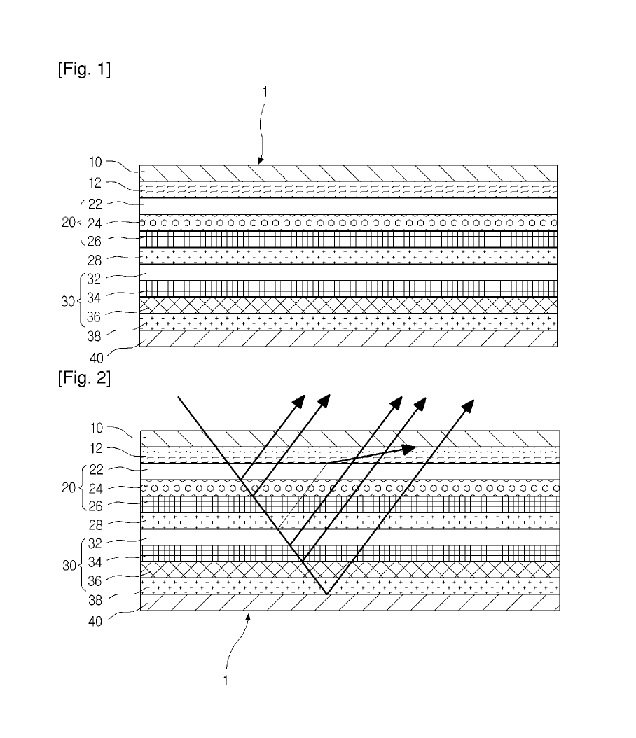

FIG. 1 is a cross-sectional view of a decoration panel according to an embodiment of the present invention and FIG. 2 is a cross-sectional view schematically showing when light is reflected from the decoration panel according to an embodiment of the present invention.

Referring to FIGS. 1 and 2, a decoration panel 1 may include green glass 10, a first film 20, a second film, and a base supporting layer 40.

To be more specific, the green glass 10 is positioned at the outermost side of the decoration panel 1 to define the external appearance and made of a transparent material to transmit a pattern or a color from a printed layer 24 behind it.

In detail, the green glass 10 can protect and support well a plurality of films under the green glass 10, provides luxurious feel to the external appearance with a high degree of luster, and particularly, has high strength and is less expensive than white glass.

When the thickness of the green glass 10 increases or bright color or light is radiated thereto, the green glass 10 itself expresses a mild green color by the component Fe contained in the green glass 10. In this configuration, since the bright-colored printed layer 24 is disposed behind the green glass 10, the inherent green color of the green glass 10 is shown only when light is reflected, and in general, the inherent color of the green glass 10 is not shown, when a dark-colored printed layer 24 is disposed behind it.

Obviously, instead of the green glass 10, the decoration panel 1 may be made of white glass having a perfect transparent color with a small amount of Fe, but this is not efficient in comparison with the green glass 10, considering the manufacturing cost.

Meanwhile, an adhesive 12 is applied to the rear side of the green glass 10. The adhesive 12 is provided to bond the green glass 10 with the first film 20, which is described below, in which a PSA (Pressure sensitive adhesive) may be applied at a thickness of about 20˜40 μm on the rear side of the green glass 10.

The first film 20 is provided to show the pattern, color, and feel of a material of the decoration panel 1 through the green glass 10. The first film 20 may includes the printed layer 24 formed by gravure printing and a first reflective layer 26 improving reflectivity such that the white color of the printed layer 24 can be shown well.

In detail, first film 20 is generally includes a first base layer 22, the printed layer 24, and the first reflective layer 26, and the colors and patterns of the printed layer 24 and the first reflective layer 26 can be shown to the outside through the first base layer 22 and the green glass 10.

In more detail, the first base layer 22 is the uppermost surface of the first film (in FIG. 1). Further, the first base layer 22 functions as the base of the printed layer 24, which is described below, and may be made of synthetic resin, such as PET (Polyethylene terephthalate), in about a 10˜40 μm thickness.

The first base layer 22 may be formed in a roll type, and the printed layer 24 and the first reflective layer 26 may be continuously printed on the bottom (in the figure) by gravure printing. Further, the first base layer 22 may be transparent such that the color and the pattern of the printed layer 24 can be transmitted.

Further, the printed layer 24 may express the color and the pattern which are implemented by the decoration panel 1. The printed layer 24 may be printed on the first base layer 22 by the gravure printing, and may be continuously printed at several times for the colors in order to implement a plurality of colors. Further, the printed layer 24 may be formed to has a thickness of about 2˜10 μm.

Meanwhile, the first reflective layer 26 is formed on the bottom of the printed layer 24. The first reflective layer 26 is provided to shield the green color of the green glass 10 such that the gravure-printed color on the printed layer 24 is not distorted and shown through the green glass 10. The first reflective layer 26 may have a white color to improve color reflectivity of the light transmitted through the printed layer 24.

In detail, the first reflective layer 26 is gravure-printed with a white ink to shield the green color of the green glass 10 by improving the reflectivity of the printed layer 24, using color reflection. The print ink used in the gravure printing is composed of about 5˜35% white inorganic pigment, 10˜20% resin, 35˜80% solvent, and 5˜10% additive for reinforcing the function of the ink.

The inorganic pigment in the components may be Ag and Zn, TiO2, and BaO etc., which have high reflectivity in white pigments, and at least two of them may be mixed. The inorganic pigments is used in a nano-particle size to maximize the reflectivity and may be gravure-printed on the bottom of the printed layer.

In particular, when the titanium oxide in the white pigments is used, the reflectivity radiated through the green glass 10 and the printed layer 24 can be maximized. Further, it is possible not only to more effectively shield the green color of the green glass 10, but to color the first reflective layer 26 very well.

The first reflective layer 26 is formed in about a thickness of 10˜40 μm such that the majority of light passing through the printed layer 24 can be reflected. Further, the intensity of the light reflected from the printed layer 24 is improved by the improvement of the reflectivity, such that the color of the printed layer 24 becomes clear and the green color of the green glass 10 can be effectively shielded.

Meanwhile, the adhesive 28 may be applied to the bottom of the first film 20, that is, the bottom of the first reflective layer 26. The adhesive 28 is provided to bond the first film 20 and a second film 30, which is described below, and may be applied in a thickness of about 20˜50 μm.

Further, the adhesive 28 may be mixed with an additive, such as metal flake, including aluminum or copper, in order to show metal feel or make the decoration member shiny. The particle size of the additional additive is 50 μm, which should be smaller than the thickness of the applied adhesive 28, and various substances, including purl, mica, silica, may be used other than the metal flake.

The additive that is added to express metal feel or shiny feel should be used without influencing the bonding performance, and if needed, the additive may be included in printing the printed layer 24 or the first reflective layer 26.

Meanwhile, the second film 30 is provided to further increase reflectivity of the incident light by reflect again the light that is transmitted without being reflected from the first film 20, and may include a second base layer 32, a second reflective layer 34, and a red solid-printing layer 36.

The second base layer 32 is the uppermost surface of the first film 20, and may be formed to support the second reflective layer 34 and the red solid-printing layer. The second base layer 32 may be made of PET that is the same as the first base layer 22, and may be formed in a thickness of about 10˜40 μm. Further, the second base layer 32 may be formed in a roll type, similar to the first base layer 22, such that the second reflective layer 34 and the red solid-printing layer 36 can be continuously formed by gravure printing.

The second reflective layer 34 is provided to reflect light transmitted through the first film 20 and made of a white inorganic pigment, the same as the first reflective layer 26, on the bottom of the second base layer 32, in a thickness of about 10˜40 μm.

The white inorganic pigment may be configured the same as the first reflective layer 26 described above. If necessary, the white inorganic pigments for the first reflective layer 26 and the second reflective layer 34 may be different substances in silver, zinc, titanium oxide, and a barium oxide.

The second reflective layer 34 can more improve reflectivity of the light from the decoration panel 1 by reflecting the color transmitted through the first film 20. Further, the second reflective layer 34 can more effectively shield the green color of the green glass 10 by improving the intensity of the reflected light to strengthen the color of the printed layer 24.

Meanwhile the red solid-printing layer 36 may be formed on the bottom of the second reflective layer 34. The red solid-printing layer 36 is provided to more effectively shield the green color of the green glass 10 may be formed with a red ink, which is the complementary color of the green, in a thickness of about 5˜10 μm by gravure printing.

In detail, the red solid-printing layer 36 shields the green color of the green glass 10, using complementary colors contrast effect, because the light becomes white color light by light mixture, when the light passing through the first film 20 and the second reflective layer 34 is reflected and passes through the green glass 10. The red solid-printing layer 36 may be removed, if needed.

Further, the adhesive 38 may be applied to the bottom of the second film 30, that is the bottom of the red solid-printing layer 36 or the second reflective layer 34. The adhesive 38 is provided to bond the second film 30 with the base supporting layer 40, which is described below, and may be the same as the adhesive 28 for bonding the first film 20 with the second film 30 described above, in a thickness of about 10˜50 μm.

The base supporting layer 40 is bonded to the second film 30 to support the first film 20 and the second film 30, and may be made of synthetic resin, such as PVC, in a thickness of about 80˜180 μm. The base supporting layer 40 can simultaneously support the first film 20 and the second film 30, because the first film 20 and the second film 30 are sequentially bonded.

Further, the base supporting layer 40 may be given a white color. In this configuration, the white inorganic pigment may be applied to the base supporting layer 40 or may be applied to the inside of the base supporting layer 40 in forming. As a result, reflectivity is more improved by color reflection in which the light transmitted through the first film 20 and the second film 30 is reflected again, such that the green color of the green glass 10 can be additionally shielded.

Further, the base supporting layer 40 may be given a red color that is the complementary color of the green color of the green glass 10, in which it can function as the red solid-printing layer 36.

That is, when the base supporting layer 40 is given a red color, white color light is achieved by light mixture when the light passing through the first film 20 and the second film 30 is reflected. As a result, the red solid-printing layer 36 may not be formed on the second film 30, because the green color of the green glass 10 can be additionally shielded.

Hereinafter, a method of manufacturing a decoration panel for a home appliance, which as the configuration described above, according to an embodiment of the present invention is described.

First, the green glass 10 having a thickness of about 3.2 mm is machined to correspond to the size of the decoration panel 1 in order to achieve the green glass 10 that defines the outer side of the decoration panel 1.

Further, the first film 20, second film 30, and base supporting layer 40 are formed. The first base layer 22 is first made of transparent synthetic resin, for example, PET, to form the first film 20. The first base layer 22 is formed in a thickness of 10˜40 μm, in a roll type such that continuous printing is possible. Further, the surface of the first base layer 22 may be coated, for example UV-coating, to improve hardness and chemical resistance etc.

Further, the first base layer 22 formed as described above is mounted in a printer and the printed layer 24 is formed on the bottom of the first base layer 22. In detail, the desired pattern and color expressed from the decoration panel 1 is implemented in a thickness of about 1˜10 μm by gravure printing.

In this configuration, the printed layer 24 may be continuously printed on the roll type first base layer 22 by the feature of gravure printing, and may be printed at several times, when various colors are included due to a difference between the background color and the pattern color.

The first reflective layer 26 may be formed on the bottom of the printed layer 24 to shield the green color of the green glass 10. The first reflective layer 26 is continuously printed by gravure printing, similar to the printed layer 24, in a thickness of about 10˜40 μm with the white inorganic pigment.

Meanwhile, the second base layer 32 is formed first to form the second film 30, in which the second base layer 32 may be formed in a thickness of about 10˜40 μm by the same method as the first base layer 22.

The second reflective layer 34 is formed on the bottom of the second base layer 32. The second reflective layer 34 may be continuously printed with the white inorganic pigment, the same as the first reflective layer 26, on the bottom of the second base layer 32 by gravure printing, in a thickness of about 10˜40 μm.

The red solid-printing layer 36 may be formed on the bottom of the second reflective layer 34. The red solid-printing layer 36 may be continuously printed on the bottom of the second reflective layer 34 by gravure printing, in a thickness of about 5˜10 μm.

Meanwhile, the base supporting layer 40 is made of PVC in a thickness of about 80˜180 μm. Further, a white inorganic pigment may be applied to the base supporting layer 40 or mixed in forming to provide the white color.

Obviously, the base supporting layer 40 may be given a red color, in which the base supporting layer 40 itself shields the green color of the green glass 10 by the complementary colors effect, such that the red solid-printing layer 36 may be removed.

The first film 20 and the second film 30 are bonded by the adhesive 28, after the first film 20, second film 30, and base supporting layer 40 are completed. The adhesive 28 may be applied to the bottom of the first film 20 in a thickness of about 20˜50 μm, and any one of metal flake, purl, mica, and silica may be added to the adhesive 28 to express metal feel.

Meanwhile, the second film 30 may be bonded to the top of the base supporting layer 40 by the adhesive 38. The adhesive 38 may be applied on the rear side of the second film 30 in a thickness of about 10˜50 μm such that the second film 30 and the base supporting layer 40 are integrally formed. That is, the adhesive 28 is applied between the first film 20 and the second film 30 and the adhesive 38 is applied between the second film 30 and the base supporting layer 40, such that the first film 20, second film 30, and base supporting layer 40 may be bonded in one film.

As described above, the first film 20, second film 30, and base supporting layer 40, which are formed in one film, adhere to the bottom of the green glass 10. That is, the adhesive 12 is applied to the bottom of the green glass 10 in a thickness of about 20˜40 μm, and the bottom of the green glass 10 and the top of the first film 20 are bonded, thereby completing the decoration panel 1.

Hereinafter, the operation of a decoration panel for a home appliance, which as the configuration described above, according to an embodiment of the present invention is described with reference to the drawings.

Referring to FIG. 2, the light traveling to the decoration panel 1 from the outside of the decoration panel 1 travels into the first film 20 through the green glass 10.

The light transmitted through the first base layer 22 reaches the first reflective layer 26. Further, the incident light mostly reflected without passing through the first reflective layer 26, by the white inorganic pigment in the first reflective layer 26.

That is, the majority of the light traveling to the decoration panel 1 is reflected again to the outside by the high reflectivity due to color reflection of the white color of the first base layer 22 and the high reflectivity of the white inorganic pigment. In this process, the white color of the printed layer 24 is more brightened the green color of the green glass 10 is shielded.

Meanwhile, some of the light radiated to the first film 20 travels into the second film 30 through the first film 20. The light traveling into the first film 30 reaches the second reflective layer 34 through the second base layer 32. The majority of incident light is reflected without passing through the second reflective layer 34 by the white inorganic pigment in the second reflective layer 34, such that the reflectivity is more improved by color reflection.

Further, some of the light radiated to the second reflective layer 34 travels into red solid-printing layer 36 through the second reflective layer 34. The red color of the red solid-printing layer 36 reflects again the light transmitted through the second reflective layer 34. In this configuration, since the red solid-printing layer 36 has the red color that is the complementary color of the green color of the green glass 10, a white color is implemented by light mixture when the light is reflected and passes through the green glass 10, such that the green color of the green glass 10 can be more shielded.

Further, the light passing through the first film 20 and the second film 30 is reflected from the base supporting layer 40, such that green color of the green glass 10 can be more effectively shielded.

As described above, the light traveling into the decoration panel 1 is reflected from the first reflective layer 26 of the first film 20 and the second reflective layer 34 of the second film 30, and the light passing through the first film 20 and the second film 30 is reflected again from the base supporting layer 40. As a result, the light traveling into the decoration panel 1 is reflected two times or three times, such that the color reflectivity is maximized.

Further, the light passing through the first film 20 and the second reflective layer 34 is reflected again from the red solid-printing layer 36, in which the reflected light becomes white color light by light mixture into a red color, which is the complementary color of the green color of the green glass 10.

That is, the reflectivity of the incident light is increased by the first film 20, second film 30, and base supporting layer 40, such that the white color of the printed layer 24 is more brightened. Further, the green color of the green glass 10 can be completely shielded by the complementary colors effect gradually generated from the red solid-printing layer 36. Therefore, even if the printed layer 24 is printed with a white color such that the decoration panel 1 has a white color, and the green glass 10 is used for the decoration panel 1, the green color of the green glass 10 can be completely shielded by the first film 20, second film 30, and base supporting layer 40; therefore, the decoration panel 1 can perfectly express the original white color.

Meanwhile, the decoration panel according to an embodiment of the present invention can be applied to various home appliances and the structure when the decoration panel is mounted in various home appliances is described hereafter.

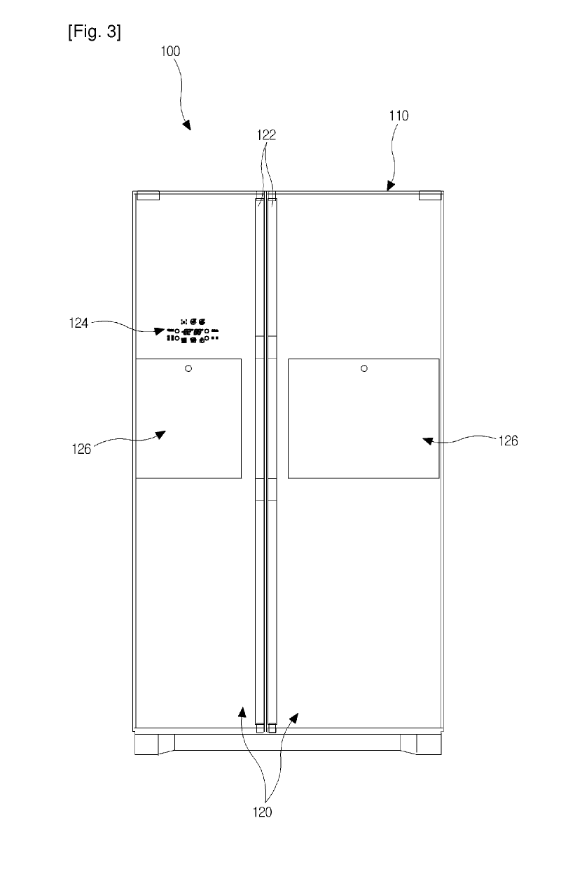

FIG. 3 is a front view of a side-by-side refrigerator equipped with the decoration panel according to an embodiment of the present invention.

Referring to FIG. 3, a refrigerator 100 includes a main body 110 having at least one storage space and doors 120 closing the storage spaces.

In detail, the storage spaces are divided in the left-right direction or the up-down direction to define a refrigerating compartment and a freezing compartment, and are selectively closed by the doors 120. A side-by-side refrigerator with storage spaces divided in the left-right direction is shown in this embodiment.

The doors 120 are hinged to the main body 100 to rotate left and right, respectively, and the refrigerating compartment and the freezing compartment are selectively closed by rotating the doors 120. Further, the doors 120 prevent the cold air from leaking out of the storage spaces and define the front external appearance of the refrigerator 100.

Handles 122 that a user grips to open the doors 120 are provided on the front side of the doors 120. Further, the doors 120 may be equipped with a display assembly 124 for checking the state and operating the refrigerator 100, home bars 126 for easily taking out the food from the storage spaces, and a dispenser (not shown) for taking out water or ice.

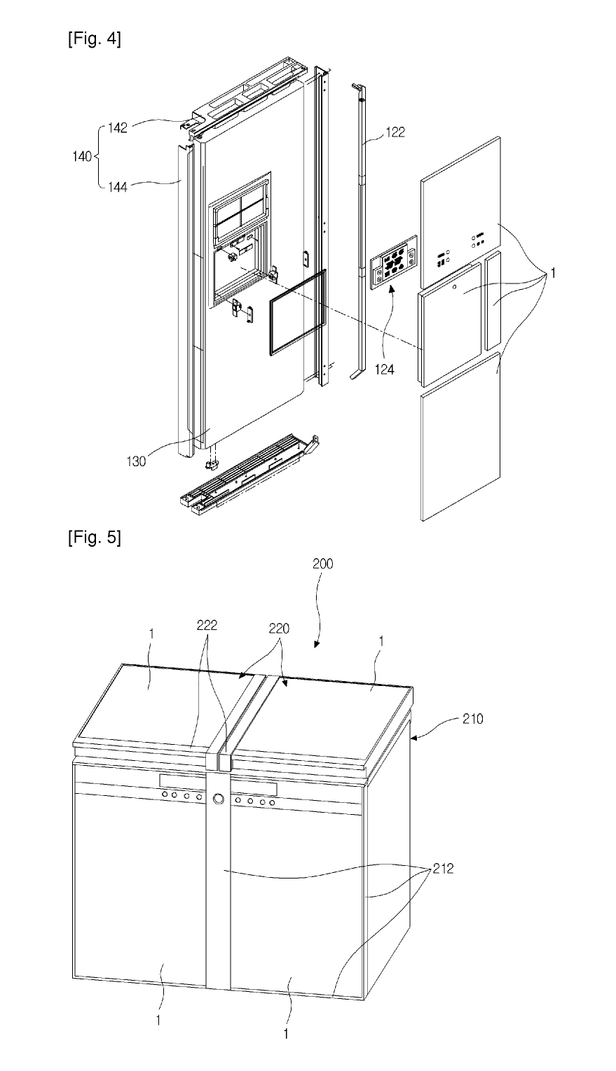

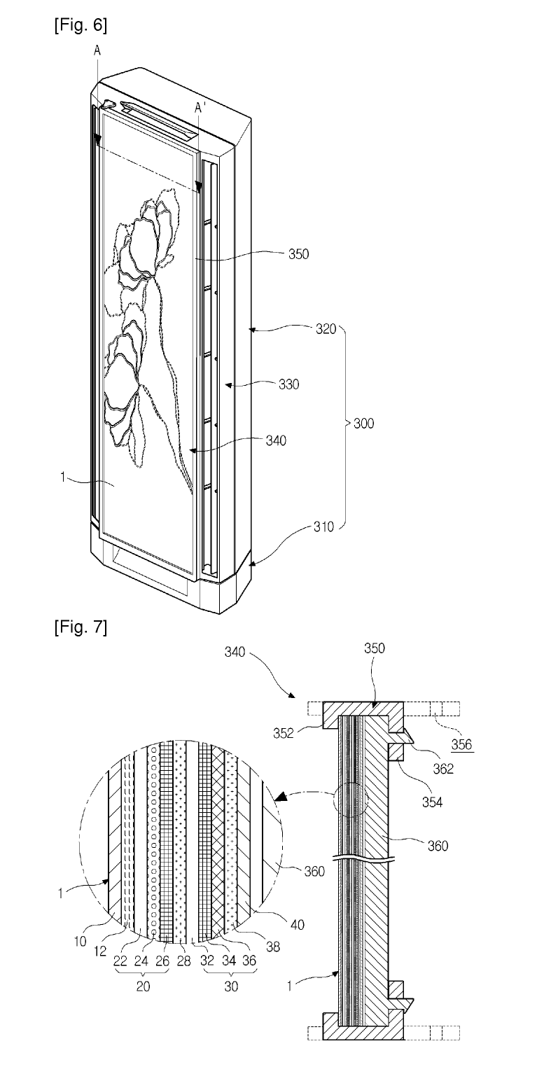

FIG. 4 is an exploded perspective view of the door shown in FIG. 3.

Describing the doors 120 with reference to FIG. 4, the doors 120 are formed in a rectangular shape with a predetermined thickness, when seen from the front. Further, the entire shape of the door 120 is formed by combining an outer case 130, a door liner (not shown), the decoration panel 1, and a frame 140 fixing them.

The outer case 130 defines the entire outer shape of the door 120 and is formed by bending the edge of a rectangular steel plate, and the display assembly 124 is mounted in the front side of the outer case 130 to check the operation state or operate the refrigerator.

The display assembly 124 may be mounted to the exposed to the outside from the door 120, and if needed, the entire display assembly 124 is mounted in the door 120 to be seen from the outside through the decoration panel 1.

The door liner is made of plastic resin to define the rear side of the door 120. Further, thought not shown in detail, the door line has a structure for mounting a receiving member for food, such as a basket, or may have a specific space for mounting the receiving member.

Meanwhile, a closed space is defined between the outer case 130 and the door liner and filled with a foamed heat insulating material. The heat insulating material may be foaming material, such as EPS (Expandable poly-styrene).

The outer case 130 and the door liner are assembled in one unit by the foamed heat insulating material, in which the frame 140 and the decoration panel 1 are combined, thereby forming the door 120.

Meanwhile, the frame 140 is disposed around the door 120. The frame 140 is disposed to fix the assembly of the outer case 130 and the door liner and the decoration panel 1, which is described in detail below, and forms the left and right sides and the upper and lower sides of the door 120.

In detail, the frame 140 is composed of cap decors 142 disposed at the upper and lower ends of the door 120 and side decors 144 disposed at the left and right sides of the door 120. The cap decor 142 is attached to the upper and lower sides of the assembly of the outer case 130 and the door liner to fix the upper end and the lower end of the decoration panel 1. Further, the side decors 144 are attached to the left and right sides, respectively, of the assembly of the outer case 130 and the door liner to fix the left and right sides of the decoration panel 1.

The decoration panel 1 defines the front side of the door 120 and formed of a rectangular plate shape corresponding to the front side of the door 120. The decoration panel 1 may be one plate corresponding to the entire front side of the door 120, or may be formed of a plurality of plates and disposed at one of the upper and lower sides and the left and right sides, when the door 120 is equipped with the home bar 126, as shown in the figure.

FIG. 5 is a perspective view of a lid type refrigerator equipped with the decoration panel according to an embodiment of the present invention.

Referring to FIG. 5, the decoration panel according to an embodiment of the present invention may be applied to the main body of a refrigerator, as well as the door of the refrigerator, as described above.

In detail, a refrigerator 200 according to an embodiment of the present invention includes a main body 210 having storage spaces with the top open and doors 220 selectively closing the storage spaces at the top of the main body 210.

The doors 200 may be one or more in accordance with the shape of the storage spaces and are rotated to open/close the spaces. Further, the top of the door 220 may be exposed to the outside and the decoration panel 1 having the same configuration as that of the embodiment described above may be disposed at the top of the door 220 such that the external appearance looks better.

The configuration of the decoration panel 1 is the same as that of the embodiment described above, and the detailed description is not provided.

In this configuration, door decors 222 are provided on the edge of the door 220 to fix the decoration panel 1 and the decoration panel 1 can defined the top of the doors 220 by the door decors 222.

Further, the front side of the main body as well as the top of the doors of the refrigerator 200 can be exposed in installing the refrigerator 200. Therefore, the decoration panel 1 having the same configuration as the decoration panel 1 of the doors 220 is provided at least on the front side of the main body such that the external appearance of the refrigerator 200 looks better. The external panel 1 from the front side of the main body 210, and if needed, may further form the other sides, including the front side and the sides, of the main body 210.

Further, the decoration panel 1 is fixed by a main decor 212 forming the edge of the main body 210, and if needed, may be fixed by another fixing member of the main body 210.

Obviously, the decoration panel 1 may be mounted on the doors 220 and the main body 210, and if needed, may be mounted on only any one of the doors 220 and the main body 210.

Therefore, the external appearance of the refrigerator 200 may be implemented by the decoration panel 1, and when the decoration panel 1 has the white color, as described with reference to the above embodiment, the green color of the green glass 100 is shielded by the first film 20, second film 30, and base supporting layer 40, thereby expressing a perfect white color.

FIG. 6 is a perspective view of an air conditioner equipped with the decoration panel according to an embodiment of the present invention and FIG. 7 is a cross-sectional view taken along the line A-A′ of FIG. 6.

Referring to FIGS. 6 and 7, a main body 300 of the indoor unit of an air conditioner equipped with the decoration panel 1 according to an embodiment of the present invention includes a base 310, a rear cabinet 320 disposed at the upper portion of the rear side of the base 310, a front cabinet 330 disposed at the upper portion of the front side of the base 310, and a front panel 340 disposed on the front side of the front cabinet 330.

A predetermined space is defined therein by assembling the base 310, rear cabinet 320, and front cabinet 330. A blowing fan and a channel for sucking/discharging air are disposed in the space, a filter assembly for filtering the intake air, a heat exchanger for exchanging heat with the intake air, and a part for implementing a refrigeration cycle are received.

Further, one or a plurality of intake port for sucking external air and a discharging port for discharging the heat-exchanging air may be formed in the base 310, the rear cabinet 320, and the front cabinet 330, respectively.

Meanwhile, the front pane 340 may be rotatably and detachably attached to the front cabinet 330. Therefore, the front side of the front cabinet 330 can be opened by rotating or detaching the front pane 340, and the parts inside/outside the front cabinet 330 can be operated and maintained.

Further, the front panel 340 defines the external shape of the front side of the indoor unit and has a structure of which the color and design can be easily changed.

In detail, the front panel 340 is composed of an edge cover 350 forming the edge of the front panel 340, a rear panel 360 fixed by the edge cover 350, and a decoration panel 1 fixed to the edge cover 350 together with the rear panel 360.

To be more specific, the decoration panel 1 is formed, as described by, the green glass 10, and the first film 20, the second film 30, and the base supporting layer 40, which are sequentially bonded to the rear side of the green glass, and is in contact with the front side of the rear panel 360 to be supported by the rear panel 360 at the rear portion.

Further, the decoration panel 1 and the rear panel 360 are fixed by the edge cover 350, overlapping each other. The edge cover 350 may form a substantially n-shaped cross section. The front side 352 of the edge cover 350 retain the front side of the decoration panel 1 and the rear side retains the rear side of the rear panel 360. In this structure, a hook hole 356 may be further formed in the rear side 354 such that a hook 362 formed at the rear panel 360 is inserted and fixed.

According to the configuration described above, the decoration panel 1 can be detached from the edge cover 350 to be replaced by others with various colors and patterns. Further, as described above with reference to the above embodiment, it is possible to express a perfect white color, shielding the green color of the green glass 10.

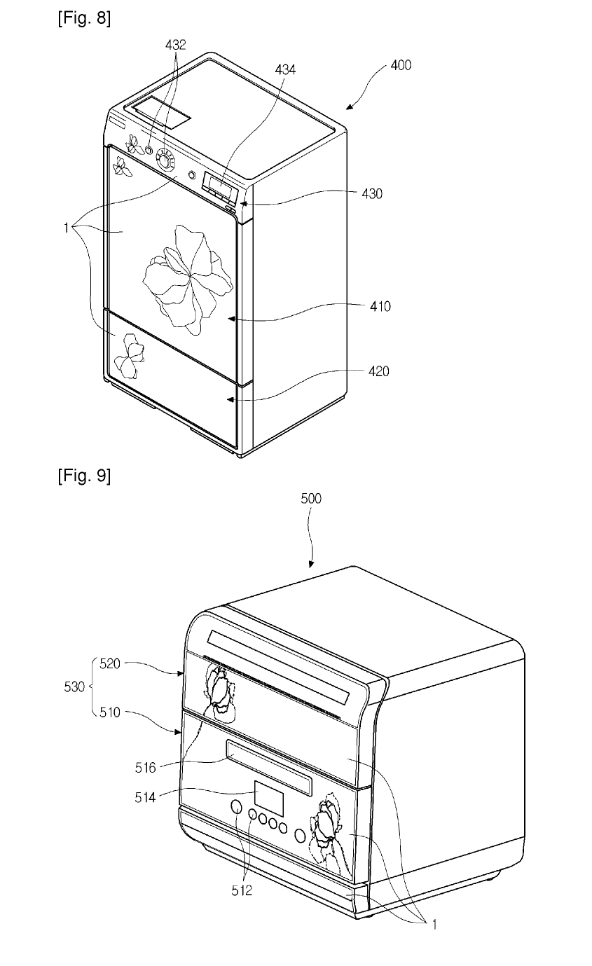

FIG. 8 is a perspective view of a washing machine equipped with the decoration panel according to an embodiment of the present invention.

Referring to FIG. 8, a main body 400 of a washing machine equipped with the decoration panel according to an embodiment of the present invention may be formed in a substantially hexahedral shape.

Though not shown in detail, the main body 400 includes a tub storing washing water, a drum rotatably disposed inside the tub and receiving laundry, a driving unit supplying rotational force for rotating the drum, a washing water supply unit supplying the washing water to the tub, and a discharging unit discharging the washing water.

Meanwhile, the front side of the main body 400 is partially open to put laundry into the drum, and the open front side of the main body 400 can be closed by a cover 410. For this configuration, the cover 410 is rotatably attached to the main body 400 and defines the front external appearance of the main body 400, when being closed. Further, a lower drawer 420 that can be drawn in/out may be disposed at the lower portion of the main body 400.

The front side of the cover 410 and the front cover of the lower drawer 420 define the front external appearance of the main body 400 of the washing machine and the decoration panel 1 may be attached to the cover 410 and the lower drawer 420. The decoration panel 1 is attached to the cover 410 and the lower drawer 420 by an adhesive. Obviously, the decoration panel 1 may be mounted on the cover 410 and the lower drawer 420 by a specific combining means or combining structure.

The decoration panel 1 defines most of the front side of the cover 410 and the lower drawer 420, and may define most of the front external appearance of the main body 400 of the washing machine. Further, the decoration panel 1 may be provided to a controller panel 430 disposed at the upper portion on the front side of the main body 400, in which the decoration panel 1 can define the entire surface, except for an operation switch 432 and a display 434 on the control panel 430.

Further, if necessary, the decoration panel 1 may be provided on the left and right sides and the rear side, or the upper side of the main body 400 of the washing machine.

Therefore, the external appearance of the main body 400 of the washing machine can be expressed by the decoration panel 1, and as in the embodiment described above, it is possible to express the perfect white color of the decoration panel 1 by shielding the green color of the green glass 10, by improvement of the reflectivity due to color reflection of the first film 20, second film 30, and base supporting layer 40 in the decoration panel 1.

FIG. 9 is a perspective view of a dish washer equipped with the decoration panel according to an embodiment of the present invention.

Referring the figure, a dish washer equipped with the decoration panel according to an embodiment of the present invention has an external shape formed by a main body 500 formed in a substantially rectangular parallelepiped.

Though not shown in detail, the main body 500 may include a cavity receiving dishes to wash, a lack member drawn into/out of the cavity and where the dishes are seated, a water supply unit supplying water for washing into the cavity, and a discharging unit discharging the water used for wash.

Further, the main body 500 is equipped with a door 510. The door 510 is formed to selectively open/close the open front side of the main body 500, and defines the front external appearance of the dish washer, when the door 510 is closed.

The door 510 is composed of an upper door 520 and a lower door 530 and has a structure in which the upper door 520 is correspondingly opened/closed when the lower door 530 is operated. Further, the door 510 may be equipped with an operation unit 512 for operating the dish washer and checking the operation state, a display 514, and a handle 516. The door 510 is formed in one unit, similar to a cooker that is described below, and can be connected to be able to rotate forward from the main body 500.

The decoration panel 1 is attached to the front side of the door 510, that is, the front sides of the upper door 520 and the lower door 530. The decoration panel 1 defines the front external appearance of the door 510 in the same configuration as that described with reference to the above embodiment.

The decoration panel 1 can be bonded to the front side of the door 510 by an adhesive, and if needed, it may be fixed to the door 510 by specific fixing means or fixing structure.

Meanwhile, the decoration panel 1 may be attached over the front region of the main body 500, except for the door 510. That is, the decoration panel 1 may be attached to one side of the front side of the main body 500 which corresponds to the upper portion of the upper door 520 and the lower portion of the lower door 530, and the front side of the main body 500 may be formed by the decoration panel 1, when the door 510 is closed.

Further, if necessary, the decoration panel 1 may be provided on the left and right sides and the rear side, or the upper side of the main body 500.

Therefore, the external appearance of the main body 500 can be expressed by the decoration panel 1, and as in the embodiment described above, it is possible to express the perfect white color of the decoration panel 1 by shielding the green color of the green glass 10, by improvement of the reflectivity due to color reflection of the first film 20, second film 30, and base supporting layer 40 in the decoration panel 1.

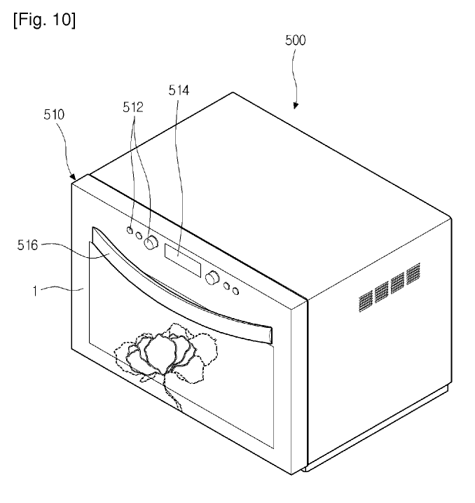

FIG. 10 is a perspective view of a cooker equipped with the decoration panel according to an embodiment of the present invention.

Referring the figure, a cooker equipped with the decoration panel according to an embodiment of the present invention has an external shape formed by a main body 500 formed in a substantially rectangular parallelepiped.

Though not shown in detail, the main body 500 may include a cavity receiving food to cook, a heating unit or a magnetron for cooking the food in the cavity, and a fan assembly for convection inside the cavity.

Further, the main body 500 is equipped with a door 510. The door 510 is formed to selectively open/close the open front side of the main body 500, and defines the front external appearance of the cooker, when the door 510 is closed.

The door 510 is rotatably hinged to the main body to selectively open/close the open front side of the cooker by rotating left and right or up and down.

Further, the door 510 may be equipped with an operation unit 512 for operating the cooker and checking the operation state, a display 514, and a handle 516. The door may be partially transparent, in which it is possible to cooking process of the food in the main body 500.

The decoration panel 1 is attached to the front side of the door 510. The decoration panel 1 defines the front external appearance of the door 510 in the same configuration as that described with reference to the above embodiment.

The decoration panel 1 can be bonded to the front side of the door 510 by an adhesive, and if needed, it may be fixed to the door 510 by specific fixing means or fixing structure. Further, the decoration panel 1 may be attached to the top or the left and right sides of the main body 500, other than the door 510.

As described above, the external appearance of the main body 500 can be expressed by the decoration panel 1, and as in the embodiment described above, it is possible to express the perfect white color of the decoration panel 1 by shielding the green color of the green glass 10, by improvement of the reflectivity due to color reflection of the first film 20, second film 30, and base supporting layer 40 in the decoration panel 1.

1. A decoration panel for a home appliance, comprising:
a green glass defining the external appearance of the appliance;
a first film disposed on a rear side of the green glass; and
a base supporting layer supporting the first film from a rear side of the first film,
wherein the first film includes:
a first base layer formed on the rear side of the green glass;
a printed layer formed on a rear side of the first base layer by gravure printing; and
a first reflective layer printed with a print ink containing a white inorganic pigment on a rear side of the printed layer by gravure printing to shield the green color of the green glass.

2. The decoration panel for a home appliance according to claim 1, further comprising a second film interposed between the first film and the base supporting layer, and
the second film includes:
a second base layer; and
a second reflective layer printed with the white inorganic pigment on a rear side of the second base layer by gravure printing to shield again the green color of the green glass.

3. The decoration panel for a home appliance according to claim 2,
wherein the white inorganic pigment includes any one of silver, zinc, titanium oxide, and barium oxide.

4. The decoration panel for a home appliance according to claim 2, further comprising a red solid-printing layer printed with a red color having complementary colors effect against the color of the green glass, on the rear side of the second reflective layer.

5. The decoration panel for a home appliance according to claim 2, further comprising an adhesive interposed between the first film and the second film,
wherein at least one or more of metal flake, purl, mica, and silica is added to the adhesive to show shiny feel of a material.

6. The decoration panel for a home appliance according to claim 2,
wherein the first base layer and the second base layer are made of PET.

7. The decoration panel for a home appliance according to claim 1,
wherein the base supporting layer is made of PVC and given with a red color that is the complementary color of the green color of the green glass.

8. A home appliance, comprising:
a main body or a door defining the external appearance; and
a decoration panel provided on the main body or the door,
wherein the decoration panel includes:
a green glass defining the external appearance of the home appliance;
a first film disposed on a rear side of the green glass; and
a base supporting layer supporting the first film from a rear side of the first film, and
the first film includes:
a first base layer formed on the rear side of the green glass;
a printed layer formed on a rear side of the first base layer by gravure printing; and
a first reflective layer printed with a print ink containing a white inorganic pigment on a rear side of the printed layer by gravure printing to shield the green color of the green glass.

9. The home appliance according to claim 8, further comprising a second film interposed between the first film and the base supporting layer, and
the second film includes:
a second base layer; and
a second reflective layer printed with the white inorganic pigment on a rear side of the second base layer by gravure printing to shield again the green color of the green glass.

10. The home appliance according to claim 9, wherein the white inorganic pigment includes any one of silver, zinc, titanium oxide, and barium oxide.

11. The home appliance according to claim 9, further comprising a red solid-printing layer printed with a red color having complementary colors effect against the color of the green glass, on the rear side of the second reflective layer.

12. The home appliance according to claim 9, further comprising an adhesive interposed between the first film and the second film, wherein at least one or more of metal flake, purl, mica, and silica is added to the adhesive to show shiny feel of a material.

13. The home appliance according to claim 9, wherein the first base layer and the second base layer are made of PET.

14. The home appliance according to claim 8, wherein the base supporting layer is made of PVC and given with a red color that is the complementary color of the green color of the green glass.

15. The home appliance according to claim 8, wherein the main body or the door is included in one of a refrigerator, a washing machine, a cooker, an air conditioner, and a disc washer.
